(19) United States
(12) Patent Application Publication
(10) Pub. No.: US 2024/0074573 A1
(43) Pub. Date: Mar. 7, 2024

(54) PRODUCT WITH BRISTLES WHICH CAN BE EASILY RECYCLED

(71) Applicant: Evonik Operation GmbH, Essen (DE)

(72) Inventors: Florian HERMES, Haltern am See (DE); Uwe Kannengießer, Xanten (DE); Alexander Richter, Haltern am See (DE); Kerstin Wieder, Muenster (DE); Johannes-Florian Krampe, Dorsten (DE)

(73) Assignee: Evonik Operation GmbH, Essen (DE)

(21) Appl. No.: 18/261,649

(22) PCT Filed: Jan. 11, 2022
(86) PCT No.: PCT/EP2022/050368

§ 371 Date: Jul. 14, 2023

(30) Foreign Application Priority Data
Jan. 18, 2021 (EP) 21152035.8

(51) Int. Cl. A46D 1/00; D01F 6/04; D01F 6/60; D01F 6/80

(52) U.S. Cl. CPC A46D 1/0207; D01F 6/04; D01F 6/60; D01F 6/80; A46B 2200/1066

(57) ABSTRACT

Brushware contains the constituents of monofilaments or bristles, and at least one head, handle, and/or neck. The constituents contain or are made of polymers from the same polymer class selected from among polymers and/or copolymers, and wherein the polymer class is selected from polyamides or polyesters.

The present invention relates to brushware which can be recycled easily since its constituents comprise the same material or consist thereof.

In the prior art, a plurality of materials, but at least one material pairing, is/are generally used in order to ensure a certain durability of the brushware. In the case of toothbrushes, for example, metal platelets are used in addition to polymer on the monofilaments or bristles. The bundled bristles are bent in a loop-like manner around these metal platelets and press into the drilled hole of the head of the brushware. An alternative is for bundled bristles to be enveloped with flowing polymer in order subsequently to anchor them in the hollow spaces of the brush head in the known process of bundle injection fitting.

In a modification of this procedure, the material of the bristles is combined with a base polymer which becomes plastic on heating. In what is known as bundle insertion fitting, the bristle bundles are enveloped with this base polymer and are inserted in the heated state into the hollow spaces of the head.

An overview of these techniques may be found in, for example, the thesis by Susanne Wurbs at the medical faculty of the Georg-August university in Göttingen, 2011. An illustration is shown by the video “How Toothbrushes Are Made”, https://www.youtube.com/watch?v=i2pllal6HmU&feature=youtu.be.

A particular problem associated with brushware made of polymer is the disposal thereof. Although keeping our environment clean has long been a matter of public consciousness, the recycling of polymers still presents a great technical challenge.

Recycling in the sense of treatment of material is carried out for only 33% of all polymers, as set forth, for example, in an Internet article by Hunold+Knoop Kunststofftechnik, https://www.hunold-knoop.de/kunststoffwissen/kunststoff-blog/details/kunststoff-recycling-3-methoden.

Here, used parts are comminuted, cleaned and separated according to types. Metallic components can be removed by melt filtration, shredding, separation or by separation according to density. Thermoplastic polymers are subsequently melted at high temperature and reprocessed.

However, separation according to types becomes more difficult, the more types are used in the article to be recycled. In the case of articles of complex composition such as a toothbrush, separation is not economically viable. Without separation according to types, a reduced material quality which is at least very difficult to control of the article made of recycled polymer has to be expected.

Only 1% of all polymers are reused in the context of recycling of raw material. In such processes, the polymer chains in the polymer are cleaved. This forms monomers, oils and gases which can be processed to give new polymers. This process is also suitable for mixed and contaminated materials. Of course, the cleavage of polymer chains in the polymer is dependent on the combination of different polymers. An example of this recycling of raw material is the unselective thermochemical production of pyrolysis oil, in which liquefied polymers are reacted in a cracker (https://www.bastcom/global/de/who-we-are/sustainability/we-drive-sustainable-solutionsicircular-economy/mass-balance-approach/chemcycling.html).

In what is known as monomer recycling, polymer chains are converted by selective chemical reactions into monomer units. An example of this is the cleavage of nylon 6 into the monomer caprolactam. The reaction products can partly be repolymerized after purification.

It is known that inclusions of other polymers in a polymer matrix which is in principle homogeneous behave like foreign bodies. This is because many polymers are chemically incompatible with one another, meaning that they develop limited adhesion when they are combined and melted. Furthermore, different polymers are in most cases not miscible with one another. It may be necessary to use “compatibilizers” in order to achieve a desired impact modification.

In the prior art, it is usually observed that even at small proportions of one polymer in another polymer, the properties of the matrix polymer are worsened to a greater extent, the more different the chemical structure of its components. Depending on the type of the included or intentionally added polymer component, completely unsatisfactory results can also be obtained.

Thus, the type purity is quite generally of increasing interest in the handling of polymer waste. The requirement to reduce the variety of polymers used is also becoming more and more important. An overview may be found in “Kunststoffe.de”, https://www.kunststoffe.delthemen/basics/recycling/werkstoffliches-recycling/artikel/recycling-von-mischkunststoffen-1001658.html

It was thus an object of the invention to provide polymer articles which take into account the abovementioned requirements and problems. Furthermore, monofilaments or bristles should have a minimum level of recovery behavior and not be brittle.

The invention accordingly provides an item of brushware comprising the constituents:
monofilaments or bristles and
at least one head, handle and/or neck,
   which is characterized in that the constituents comprise or consist of polymers of the same class of polymers selected from among polymers and/or copolymers.

The invention is explained in more detail below.

The brushware according to the invention can have at least one grip element on its head, on the handle and/or on its neck, where the at least one grip element comprises or consists of polymers from the same polymer class (e.g. polyamide and polyether block amide) as the constituents of the brushware.

The constituents of the brushware can preferably consist of polymers of the same polymer class. Such an ideal type purity simplifies recycling to a great extent.

It can also be advantageous for the polymer or copolymer of the brushware of the invention to be selected from among polymers of the monomers hexamethylenediamine/azelaic acid, hexamethylenediamine/dodecanedioic acid, 11-aminoundecanoic acid, ω-aminododecanoic acid, laurolactam, tetramethylenediamine/adipic acid, dodecanediamine/dodecanedioic acid, caprolactam/laurolactam, hexamethylenediamine/decanedioic acid, 1,10-decamethylenediamine/1,10-decanedioic acid.

The polymer or copolymer of the brushware of the invention can particularly preferably be a polymer derived from the monomers laurolactam, 11-aminoundecanoic acid, ω-aminododecanoic acid, dodecanediamine/dodecanedioic acid, 1,10-decamethylenediamine/1,10-decanedioic acid, more particularly preferably selected from among 11-aminoundecanoic acid, ω-aminododecanoic acid, laurolactam.

The polymer of the brushware of the invention can also particularly preferably be selected from polyethylene terephthalate (PET), acid-modified polyethylene terephthalate (FETA), glycol-modified polyethylene terephthalate (PETG), polybutylene terephthalate (PBT), acid-modified polycyclohexylenedimethylene terephthalate (PCT-A) and glycol-modified polycyclohexylenedimethylene terephthalate (PCT-G).

Some materials are also known to a person skilled in the art under the following names, which are also used in the context of the invention.

Polyamide derived from:

| | |
|---|---|
| Hexamethylenediamine/azelaic acid | PA6.9 |
| Hexamethylenediamine/dodecanedioic acid | PA6.12 |
| 11-Aminoundecanoic acid | PA11 |
| Laurolactam or ω-aminododecanoic acid | PA12 |
| Tetramethylenediamine/adipic acid | PA4.6 |
| Dodecanediamine/dodecanedioic acid | PA12.12 |
| Caprolactam/laurolactam | PA6.12 |
| 1,10-decamethylenediamine/1,10-decanedioic acid | PA10.10 |
| Hexamethylenediamine/decanedioic acid | PA610 |
| Polyamide | PA |
| Polybutylene terephthalate | PBT |
| Polypropylene | PP |
| Polyether block amide | PEBA |

The brushware according to the invention can very particularly preferably be a toothbrush.

The following examples illustrate the invention further.

In all examples, toothbrushes made of various materials or various combinations of materials were subjected to conventional recycling processes. Here, the suitability for mechanical and chemical recycling and also the adhesion of the materials were evaluated in each case.

For the purposes of the invention,
Suitability for mechanical recycling means that a largely type-pure polymer can be recovered.

A “poor” suitability means that mixtures of different polymers or differently modified polymers which have an adverse effect on, for example, colour, mechanical properties, toxicology are present.
Suitability for monomer recycling means that a largely type-pure polymer can be recovered. Since small amounts of impurities can be separated off, the process can in principle be utilized more broadly than mechanical recycling.

A “poor” suitability here means that complicated additional separation steps are necessary because of complex material mixtures used.
Adhesion of the materials means that the two materials cannot be separated under stress. This can, for example, be tested in a tensile test in accordance with DIN EN ISO 527.
Cleaning action means that the brushware is capable of technical configuration in the required stiffness from soft to hard. The recovery behavior of the bristles meets the requirements and the bristles fatigue more slowly compared to other materials.
Suitability for filament extrusion means that small filament diameters for brushware may be produced without filament tearing in production. Semicrystalline thermoplastics allow stretching to strengthen the material in the force direction in filament extrusion.
Resistance to break means that the brushware is not brittle and does not break even after long-term use in toothbrushing.

Sources of supply for
PA612: VESTAMID® D16, Evonik;
PA12: VESTAMID® LX9039, Evonik;
SEBS: Delene 1010, Lingen Plastic Rubber;
PMMA: ACRYLITE® SuPure, Röhm;
PC: 4Lex 10F10000, 4Plas;
PS: ACLCOM MED PS, MOCOM;
PBT: VESTODUR 2000, Evonik.

Comparative Examples 1-6. Toothbrush comprising in each case a material combination of PA6.12 and PP, PA6.12 and PET, PA6.12, PP and block copolymer of styrene-ethylene-butylene-styrene (SEBS), PA6.12 and PE, PA612 and Ply. PA6.12 and PA12.

Comparative Examples 7-9. Toothbrush whose bristles and handle each consist of the same material: PMMA, PS or SEBS, wherein the brushware does not exhibit sufficiently good properties.

Examples 1-3. Toothbrush according to the invention whose bristles, head, handle and neck each consist of the same polymer: PA6.12 or PA12 or PBT.

Examples 4 and 5. Toothbrush according to the invention whose bristles, head, handle and neck each consist of the same polymer, namely PBT or PA12, and which additionally has a grip element composed of PEBA based on PA12 or of PEBA based on PA6.12. The evaluations are summarized in Table 1. The symbols have the following meanings:

TABLE 1
Evaluations of the recyclability of the toothbrush, of the adhesion
of the materials and evaluation of the material as brushware.

| | | | | Suitability | Suitability | | | | |
|---|---|---|---|---|---|---|---|---|---|
| | | Head, | | for | for | Adhesion | | Suitability | |
| | | handle | Grip | mechanical | monomer | of the | Cleaning | for filament | Resistance |
| | Bristles | and neck | element | recycling | recycling | materials | action | extrusion | to break |
| Comparative | PA6.12 | PP | | − | − | − | + | + | + |
| example 1 | | | | | | | | | |
| Comparative | PA6.12 | PET | | − | − | − | + | + | + |
| example 2 | | | | | | | | | |
| Comparative | PA6.12 | PP | SEBS | − | − | − | + | + | + |
| example 3 | | | | | | | | | |
| Comparative | PA6.12 | PE | | − | − | − | + | + | + |
| example 4 | | | | | | | | | |
| Comparative | PA6.12 | PU | | − | − | − | + | + | + |
| example 5 | | | | | | | | | |
| Comparative | PA6.12 | PA12 | | − | − | − | + | + | + |
| example 6 | | | | | | | | | |
| Comparative | PMMA | PMMA | | + | + | + | s | b | − |
| example 7 | | | | | | | | | |
| Comparative | PS | PS | | + | + | + | s | b | − |
| example 8 | | | | | | | | | |
| Comparative | SEBS | SEBS | | + | + | + | w | b | − |
| example 9 | | | | | | | | | |
| Example 1 | PA6.12 | PA6.12 | | + | + | + | + | + | + |
| Example 2 | PA12 | PA12 | | + | + | + | + | + | + |
| Example 3 | PBT | PBT | | + | + | + | + | + | + |
| Example 4 | PA12 | PA12 | PEBA | + | + | + | + | + | + |
| | | | (PA12) | | | | | | |
| Example 5 | PA6.12 | PA6.12 | PEBA | + | + | + | + | + | + |
| | | | (PA6.12) | | | | | | |

“−” “poor”
“+” “good”
“s” “too brittle”
“b” “only limited”
“w” “too soft”

1: Brushware, comprising the constituents of:
monofilaments or bristles, and
at least one head, handle, and/or neck,
wherein
the constituents comprise polymers and/or copolymers from the same polymer class, and wherein the polymer class is selected from the group consisting of polyamides and polyesters.

2: The brushware according to claim 1, wherein the at least one head, handle, and/or neck has at least one grip element, and the at least one grip element comprises polymers from the same polymer class as the constituents.

3: The brushware according to claim 1, wherein the constituents consist of polymers of the same polymer class.

4: The brushware according to claim 1, wherein the polymer or copolymer is selected from polymers derived from the monomers selected from the group consisting of hexamethylenediamine/azelaic acid, hexamethylenediamine/dodecanedioic acid, 11-aminoundecanoic acid, ω-aminododecanoic acid, laurolactam, tetramethylenediamine/adipic acid, dodecanediamine/dodecanedioic acid, caprolactam/laurolactam, hexamethylenediamine/decanedioic acid, and 1,10-decamethylenediamine/1,10-decanedioic acid.

5: The brushware according to claim 4, wherein the polymer or copolymer is a polymer derived from monomers selected from the group consisting of laurolactam, 11-aminoundecanoic acid, ω-aminododecanoic acid, dodecanediamine/dodecanedioic acid, and 1,10-decamethylenediamine/1,10-decanedioic acid.

6: The brushware according to claim 1, wherein the polymer is selected from the group consisting of polyethylene terephthalate (PET), acid-modified polyethylene terephthalate (PETA), glycol-modified polyethylene terephthalate (PETG), polybutylene terephthalate (PBT), acid-modified polycyclohexylenedimethylene terephthalate (PCT-A) and glycol-modified polycyclohexylenedimethylene terephthalate (PCT-G).

7: The brushware according to claim 1, wherein the brushware is a toothbrush.

8: The brushware according to claim 5, wherein the monomers are selected from the group consisting of 11-aminoundecanoic acid, ω-aminododecanoic acid, and laurolactam.
